(19) United States
(12) Patent Application Publication
(10) Pub. No.: US 2007/0204127 A1
(43) Pub. Date: Aug. 30, 2007

(54) Memory allocation method for reducing memory fragmenting

(75) Inventors: Angelo Lin, Changhua County (TW); Chih-Wei Li, Keelung City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/709,267

(22) Filed: Feb. 22, 2007

(30) Foreign Application Priority Data
Feb. 24, 2006 (TW) 95106273

(51) Int. Cl. G06F 12/00

(52) U.S. Cl. 711/170

(57) ABSTRACT

A memory allocation method comprises: providing a memory, wherein a memory block of the memory has a first side and a second side; providing a memory controller; determining a memory allocation direction, wherein the first side is a starting point of a first allocation direction when the memory allocation direction is the first allocation direction and the second side is a starting point of a second allocation direction when the memory allocation direction is the second allocation direction; the memory controller allocates a part of the memory for a client program according to a corresponding memory allocation direction.

### BACKGROUND OF THE INVENTION

1. Field of the Invention

The present invention relates to a memory allocation method, and more particularly to a memory allocation method reducing memory fragmenting.

2. Description of the Related Art

Due to the limitation of memory size, embedded system uses heap memory for dynamically allocating heap memory as needed. When a memory request of one application program is sent to the operating system, the operating system allocates a memory block to the application program and the application program returns the memory block as the program ends. If many programs send memory requests to the operating system and not return the memory at the same time, the memory is easily fragmented and the performance of the memory suffers. FIG. 1 is a schematic diagram of memory fragmentation caused by a conventional memory allocation method. In step S11, memory device 10 is initialized, thus, the entire memory device 10 is free. In step S12, memory device 10 respectively allocates memory block 11, memory block 12 and memory block 13 for program A, B and C in response to the memory request therefrom, thus, only memory block 14 of memory 10 is free. In step S13, program B returns the memory block 12 to the memory device 10, thus, the size of free memory of memory device 10 is the sum of the sizes of memory blocks 12 and 14. However, when the memory size requested by one program is more than the size of any one of memory blocks 12 and 14 and less than the sum of the sizes of memory blocks 12 and 14, there is not enough memory to run the program because the allocated memory is inseparable.

### BRIEF SUMMARY OF THE INVENTION

The invention provides a memory allocation method and system reducing memory fragment.

The invention provides a memory allocation method comprising the following steps: providing a memory, wherein a memory block of the memory has a first side and a second side; providing a memory controller for determining a memory allocation direction, wherein the first side is a starting point of a first allocation direction when the memory allocation direction is the first allocation direction and the second side is a starting point of a second allocation direction, when the memory allocation direction is the second allocation direction. When a memory request of one application program is sent to the memory controller, the memory controller allocates a part of the memory for a client program according to a corresponding memory allocation direction.

The invention further provides a memory allocation system comprising a application program, a memory, a memory controller and a memory allocation lookup table. The memory comprising a plurality of memory blocks has a first side and a second side. When a memory request of one application program is sent to the memory controller, the memory controller searches a memory allocation direction of one application program in the memory allocation lookup table, wherein the memory allocation direction selectively begins at the first side and the second side.

One embodiment of a memory allocation method for a memory having a first side and a second side is provided, comprising receiving a memory allocation request of an application program; determining an allocation direction of the application program by a usage index of the application program; wherein the allocation direction being selectively the first side and the second side.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 a schematic diagram of memory fragment caused by a conventional memory allocation method.

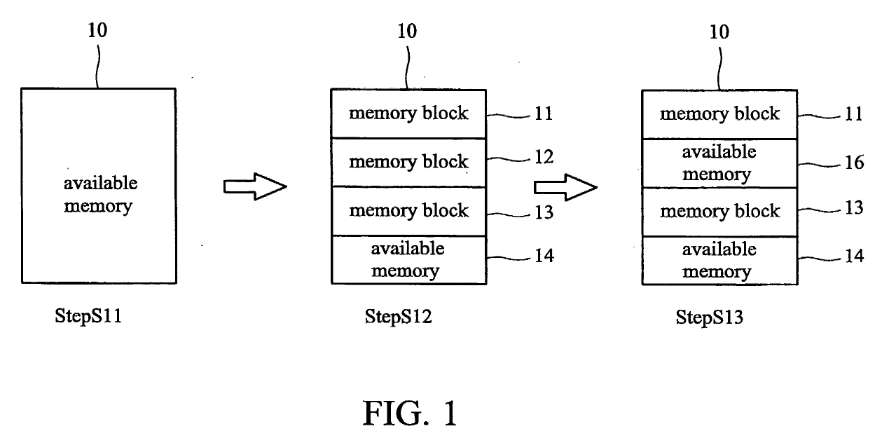

FIG. 2 is a flow chart of an embodiment based on the principle of the invention.

FIG. 3 is a memory allocation lookup table of one embodiment of the invention.

FIG. 4 is a schematic diagram of the memory allocation based on the memory allocation lookup table of FIG. 3.

FIG. 5 is a schematic diagram of another embodiment of the memory allocation based on the memory allocation lookup table of FIG. 3.

FIG. 6 is a block diagram of one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

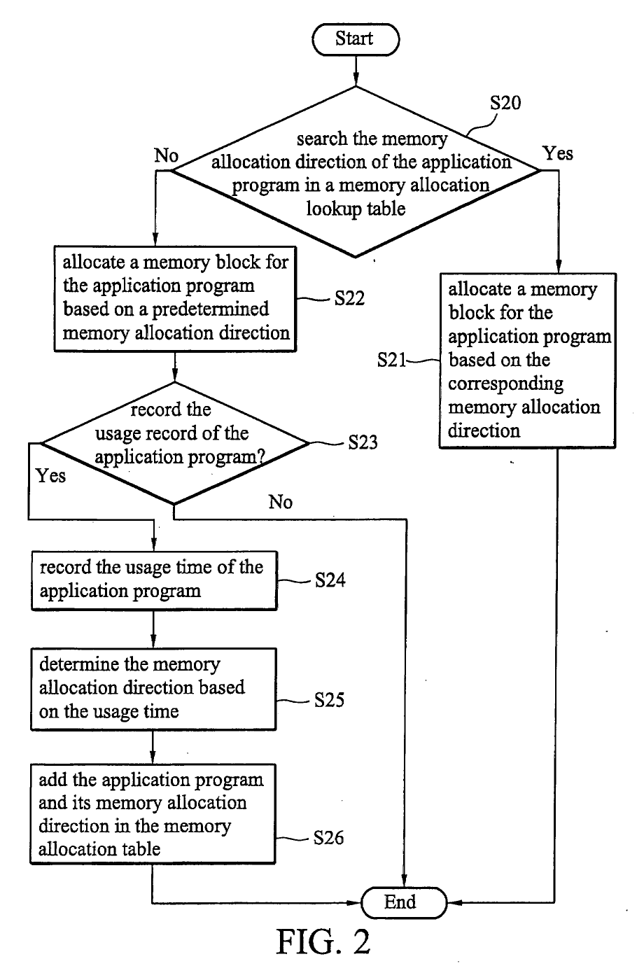

FIG. 2 is a flow chart of an embodiment based on the principle of the invention. When one application program sends a memory request to operating system (OS), the OS searches the memory allocation direction of the application program in a memory allocation lookup table (step S20). If the memory allocation direction is available, OS allocates a memory block for the application program based on the memory allocation direction of the application program (step S21). If the memory allocation direction is not available for the memory request, OS allocates a memory block for the application program based on a predetermined memory allocation direction (step S22). Then, the OS determines whether the memory allocation lookup table records the usage record of the application program (step S23). If not, OS ends the procedure. If so, the method jumps to step S24. In step S24, the usage time of the application program is recorded and the memory allocation direction is determined based on the usage time (step S25). In step S26, the memory allocation direction is added to the memory allocation lookup table.

The memory allocation lookup table records a plurality of memory allocation directions and usage times of the corresponding application program. In the invention, a standard time is determined in accordance with the usage times, wherein the standard time is an average, a median or any evaluating value of the usage times. When one application program is not recorded in the memory allocation lookup table, a predetermined memory allocation direction is applied, and in one embodiment of the invention, the memory allocation lookup table adds the usage time of the application program and re-evaluates the standard time dynamically.

In the invention, the memory allocation direction begins at a first side or a second side of a memory, wherein the memory can be divided into a plurality of memory blocks. When the usage time of one application program exceeds the standard time, the memory block allocated for the application program begins at the first side, i.e. the memory allocation direction begins at the first side. When the usage time of one application program does not exceed the standard time, the memory block allocated for the application program begins at the second side, i.e. the memory allocation direction begins at the second side. Moreover, the predetermined memory allocation direction starts at the second side.

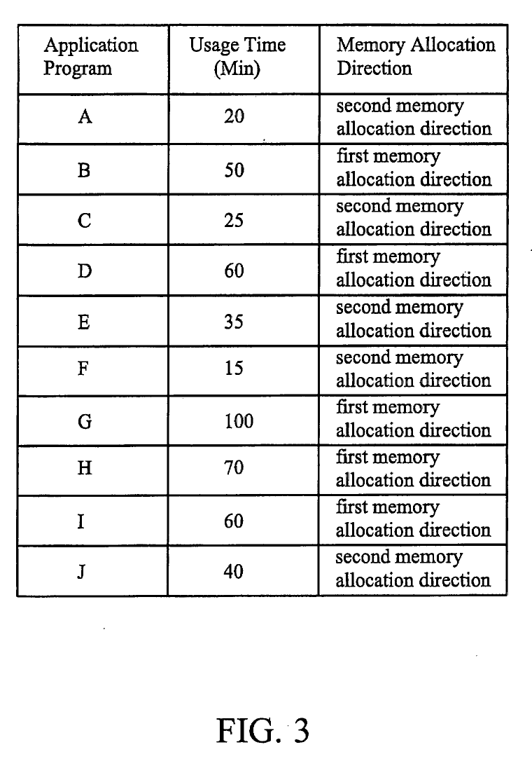

FIG. 3 is a memory allocation lookup table of one embodiment of the invention. In FIG. 3, the usage times of application programs A˜J are recorded and a standard time is determined based on the usage times. When the usage time of one application program exceeds the standard time, the memory allocation direction begins at the first side. When the usage time of one application program does not exceed the standard time, the memory allocation direction begins at the second side. In one embodiment, the standard time, 47.5 minutes, is the average time of the usage times of application programs A˜J. In another embodiment, the standard time, 45 minutes, is the mean time of the usage times of application programs A˜J. Furthermore, the standard time can be preset or determined based on calculating the usage times of application programs A˜J.

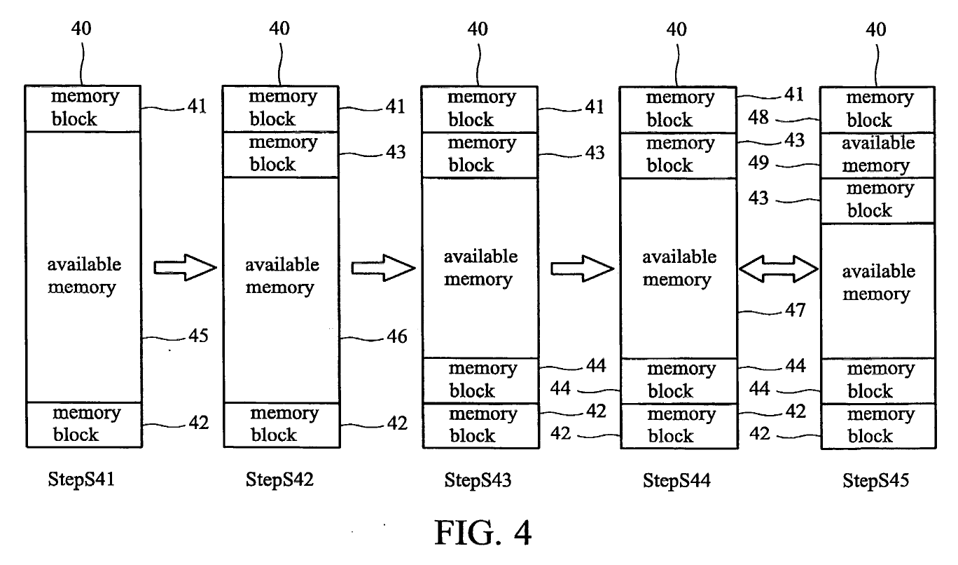

FIG. 4 is a schematic diagram of the memory allocation based on the memory allocation lookup table of FIG. 3. In FIG. 4, the first side is the bottom of the memory 40 and the second side is the top of the memory 40. In step S41, a memory block 41 is allocated to the application program A and a memory block 42 is allocated to the application program B. In step S42, the application program C sends a memory request to the OS, then, the OS search the memory allocation lookup table of FIG. 3 to determine the memory allocation direction of the application program C. According to the memory allocation lookup table of FIG. 3, it is found that the memory allocation direction of the application program C begins at the second side, thus, the OS allocates a memory block 43 from the top of the available memory 45 to the application program C. In step S43, the application program D sends a memory request to the OS, then, the OS searches the memory allocation lookup table of FIG. 3 to determine the memory allocation direction of the application program D. According to the memory allocation lookup table of FIG. 3, it is found that the memory allocation direction of the application program D begins at the first side, thus, the OS allocates a memory block 44 from the top of the available memory 46 to the application program D.

In step S44, the application program A returns the memory block 41 to the OS, thus, the memory block 41 is available. In step S45, the application program E sends a memory request to the OS, then, the OS searches the memory allocation lookup table of FIG. 3 to determine the memory allocation direction of the application program E. According to the memory allocation lookup table of FIG. 3, it is found that the memory allocation direction of the application program E begins at the second side. If the size of the memory block requested by the application program E is smaller than the size of the memory block 41, the OS allocates a memory block to the application program E beginning at the top of the memory block 41. If the size of the memory block requested by the application program E is larger than the size of the memory block 41, the OS allocates a memory block to the application program E beginning at the top of the available memory 47. In this embodiment, the size of the memory block requested by the application program E is smaller than the size of the memory block 41, thus, a memory block 48 from the top of the memory block 41 is allocated to the application program E.

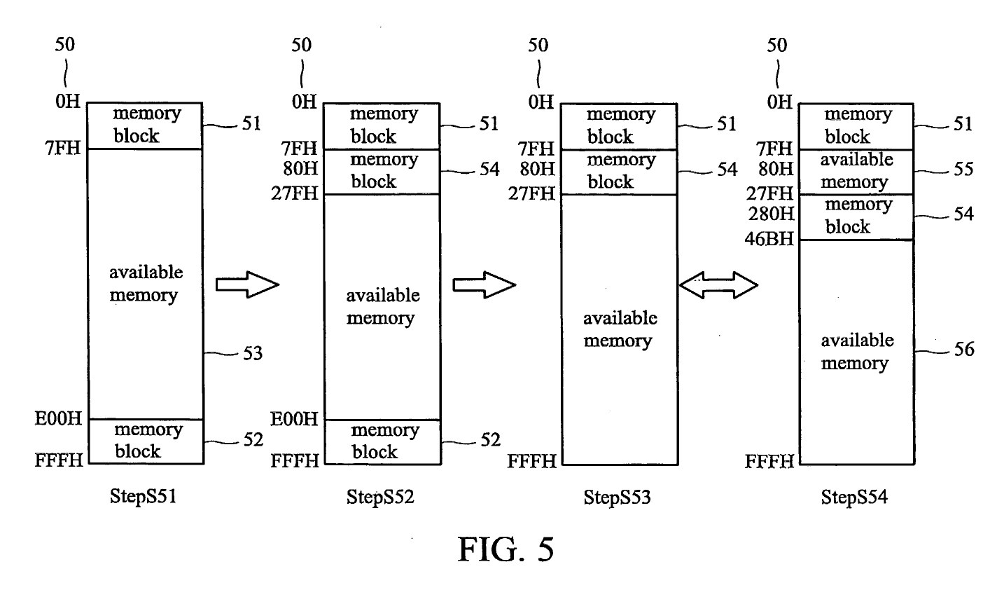

To further illustrate the invention, please refer to FIG. 5. FIG. 5 is a schematic diagram of another embodiment of the memory allocation based on the memory allocation lookup table of FIG. 3. In this embodiment, the size of the memory 50 is 1000H×20H bytes. In step S51, the application program A requests a memory block of 80H×20H bytes. Because the memory allocation direction of the application program A begins at the second side of the memory 50, i.e. the bottom of the memory 50, the OS allocates a memory block 51 from 00H to 7FH to the application program A. In step S51, the application program B requests a memory block of 200H×20H bytes. Because the memory allocation direction of the application program B begins at the first side of the memory 50, i.e. the top of the memory 50, the OS allocates a memory block 52 from E00H to FFFH to the application program B. In step S52, the application program C requests a memory block of 200H×20H bytes. Because the memory allocation direction of the application program C begins at the second side of the available memory 53, the OS allocates a memory block 54 from 80H to 27FH to the application program C. In the step S53, the application program B returns the memory block 52, thus, the single largest available memory size of the memory 50 is D80H×20H. Please refer to step S54. Step S54 is a schematic diagram of the memory allocation based on a conventional memory allocation method. In the step S54, the total available memory size is the same as the total available memory size of step S53, but the single largest available memory of memory 50 is B82H×20H. According to the results of step S53 and step S54, it is found that the memory allocation method of the invention increases the performance of memory and reduces memory fragmenting.

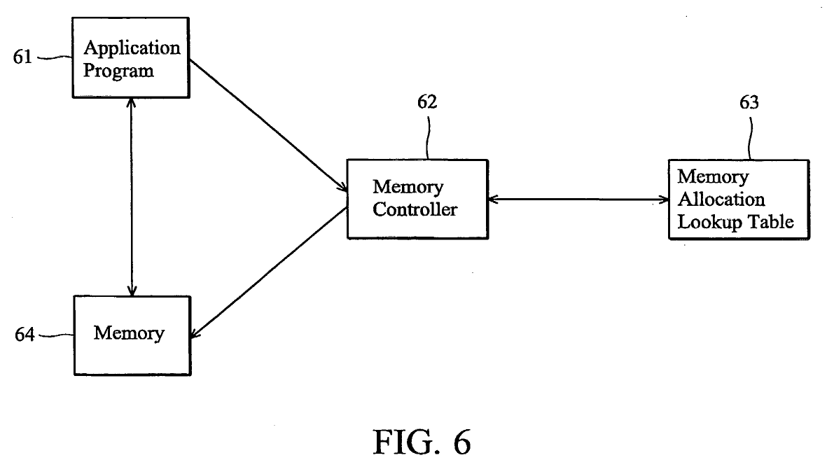

FIG. 6 is a block diagram of one embodiment of the invention. When the application program 61 sends a memory request to the memory controller 62, the memory controller 62 searches the memory allocation direction of the application program 61 in the memory allocation lookup table 63 and allocates the memory 64 based on the memory allocation direction. If the memory allocation lookup table 63 does not record the memory allocation direction of the application program, a predetermined memory allocation direction is applied. In one embodiment of the invention, the memory allocation direction can begin at a first side or a second side of the memory 64, wherein the first side is the bottom of the memory 64, such as the most significant bit or FFFH of FIG. 5, and the second side is the top of the memory 64, such as the least significant bit or 000H of FIG. 5. In another embodiment of the invention, the first side is the top of the memory 64, such as the most significant bit or 000H of FIG. 5, and the second side is the bottom of the memory 64, such as the least significant bit or FFFH of FIG. 5.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory allocation method for a memory having a first side and a second side, comprising:
receiving a request for an application program;
determining an allocation direction of the application program by searching a memory allocation lookup table; and
wherein the allocation direction being selectively the first side and the second side.

2. The method as claimed in claim 1, further comprising building the memory allocation lookup table.

3. The method as claimed in claim 2, wherein the step of building the memory allocation lookup table further comprises:
detecting a plurality of usage times of a plurality of application programs;
determining a predetermined time based on the usage time periods;
when the usage time of the application program exceeds the predetermined time, the allocation direction is the first side; and
when the usage time of the application program does not exceed the predetermined time, the allocation direction is the second side.

4. The method as claimed in claim 3, wherein the predetermined time is an average of the usage time periods.

5. The method as claimed in claim 3, wherein the predetermined time is a median of the usage time periods

6. The method as claimed in claim 3, wherein if a memory allocation direction of a first application program is not found in the memory allocation lookup table, the memory allocation direction begins at the second side.

7. The method as claimed in claim 6, further comprising:
recording the usage time of the first application program;
determining an adjusted predetermined time based on the usage times and the usage time of the first application program;
determining a memory allocation direction of the first application program by comparing the usage time of the first application with the adjusted predetermined time; and
adding the first application program and the corresponding memory allocation direction in the memory allocation lookup table.

8. The method as claimed in claim 7, wherein the adjusted predetermined time is an average time of the usage times and the usage time of the first application program.

9. A memory allocation system, comprising:
a memory having a first side and a second side;
a memory allocation lookup table; and
a memory controller for searching a memory allocation direction of a application program in the memory allocation lookup table, wherein the memory allocation direction selectively begins at the first side and the second side.

10. The system as claimed in claim 9, wherein the memory allocation lookup table records a plurality of application programs and corresponding memory allocation direction.

11. The system as claimed in claim 10, wherein when the usage time of the application program exceeds the predetermined time, the allocation direction is the first side, and when the usage time of the application program does not exceed the predetermined time, the allocation direction is the second side.

12. The system as claimed in claim 10, wherein the memory controller allocates a memory block beginning at the first side of the application program whose memory allocation direction begins at the first side, and the memory controller allocates a memory block beginning at the second side of the application program whose memory allocation direction begins at the second side.

13. The system as claimed in claim 9, wherein when the memory allocation direction of the application program is not found in the memory allocation lookup table, the memory allocation direction begins at the second side.

14. The system as claimed in claim 9, wherein a method for building the memory allocation lookup table comprises:
detecting a plurality of usage times of a plurality of application programs;
determining a predetermined time based on the usage time periods;
when the usage time of the application program exceeds the predetermined time, the allocation direction is the first side; and
when the usage time of the application program does not exceed the predetermined time, the allocation direction is the second side.

15. The system as claimed in claim 14, wherein if a memory allocation direction of a first application program is not found in the memory allocation lookup table, a predetermined memory allocation direction is applied.

16. The system as claimed in claim 14, further comprising:
recording the usage time of the first application program;
determining an adjusted predetermined time based on the usage times and the usage time of the first application program;
determining a memory allocation direction of the first application program by comparing the usage time of the first application with the adjusted predetermined time; and
adding the first application program and the corresponding memory allocation direction in the memory allocation lookup table.

17. The system as claimed in claim 16, wherein the adjusted predetermined time is an average time of the usage times and the usage time of the first application program.

18. The system as claimed in claim 9, wherein the first side begins at a relative most significant bit and the second side begins at a relative least significant bit.

19. A memory allocation method for a memory having a first side and a second side, comprising:
receiving a memory allocation request of an application program;
determining an allocation direction of the application program by a usage index of the application program; and
wherein the allocation direction being selectively the first side and the second side.

20. The method as claimed in claim 19, the method further comprising:
detecting a plurality of usage times of a plurality of application programs;
determining a predetermined time;
determining the usage index of the application program according to a usage time of the application program and the predetermined time;
when the usage time of the application program exceeds the predetermined time, the usage index of the application program is the first side; and
when the usage time of the application program does not exceed the predetermined time, the usage index of the application program is the second side.
